(19) United States
(12) Patent Application Publication
(10) Pub. No.: US 2010/0178426 A1
(43) Pub. Date: Jul. 15, 2010

(54) Structure and method for terminating underfilm corrosion

(76) Inventors: Oliver Steinbock, Tallahassee, FL (US); Stephanie D. Thouvenel-Romans, Milton, FL (US)

Correspondence Address: WILEY HORTON, 215 SOUTH MONROE STREET, 2ND FLOOR, TALLAHASSEE, FL, 32301, US

(21) Appl. No.: 12/378,211

(22) Filed: Feb. 12, 2009

Related U.S. Application Data
(63) Continuation-in-part of application No. 11/228,745, filed on Sep. 16, 2005, now abandoned.

(51) Int. Cl. B05D 5/00; B05D 1/02; B05D 1/32; B05D 1/36; C09D 5/00

(52) U.S. Cl. 427/259; 427/286; 427/277; 427/265

(57) ABSTRACT

A new structure and method for terminating underfilm corrosion. The method utilizes patterned coatings on metal surfaces creating spatial variations of coating thickness or composition. The resulting structure, or paths of structural variation in the coating, directs the path of filiform growth and promotes entrapment, thereby limiting filiform growth and causing self-annihilation. In the preferred embodiment a stamp is used to impose the desired “paths” of structural variation in the painted coating while the coating is wet.

### CROSS-REFERENCES TO RELATED APPLICATIONS

This application is a continuation-in-part of U.S. patent application Ser. No. 11/228,745

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of corrosion control. More specifically, the invention comprises a structure and method for controlling underfilm and filiform corrosion by the application of patterned coatings on metal surfaces.

2. Description of the Related Art

Corrosion is a major concern to industries who utilize steel and aluminum alloys or any other reactive surfaces. Underfilm corrosion (sometimes referred to as filiform corrosion), like other forms of corrosion, is an electrochemical reaction that occurs when metals are exposed to moisture and oxygen in the atmosphere. This kind of corrosion typically occurs under coated surfaces that are exposed to high relative humidity. Underfilm or filiform corrosion leads to the deposition of a multitude of rust trails on metal surfaces, which can be both unsightly and damaging to the surface's physical properties such as reflectivity. Underfilm corrosion is particularly significant to companies that employ metal-based materials and products that need to endure long-term storage before use or distribution to customers, especially those who employ metal cans for storage of their product.

Rust filaments (“filiforms”) have a width up to 4 mm and can extend over several decimeters. Active corrosion occurs only at the filiform head. This region is an oxygen concentration cell for which potential differences of up to 360 mV have been reported. Filiforms progress across the surface in a serpentine or linear fashion and the path of corrosion they leave is commonly referred to as the tail of the filiform. Since filiforms do not cross inactive tails of other filaments, they can become trapped and eventually “die” as the available space decreases.

Current technology protects metal surfaces with coatings of a generally uniform thickness and composition. While this is sometimes helpful to prevent the onset of corrosion, these homogenous coatings are ineffective to prevent the spread of underfilm corrosion once it has nucleated. The primary goal of the present invention is to control and exterminate corrosion once it has begun.

### BRIEF SUMMARY OF THE INVENTION

The present invention comprises a new method and structure for terminating underfilm corrosion. The method utilizes patterned coatings on metal surfaces creating spatial variations of coating thickness or composition. The resulting structure, or paths of structural variation in the coating, directs the path of filiform growth and promotes entrapment, thereby limiting filiform growth and causing self-annihilation. In the preferred embodiment a stamp is used to impose the desired “paths” of structural variation in the painted coating while the coating is wet.

### BRIEF DESCRIPTION OF THE SEVERAL VIEWS OF THE DRAWINGS

FIG. 1 is a perspective view, showing a coated metal object.

FIG. 2 is a perspective view, showing filiform corrosion on a coated metal object.

FIG. 3 is a perspective view, showing filiform self-entrapment.

FIG. 4 is a perspective view, showing a coated metal object with varying coating thickness.

FIG. 5 is a cut-away view, showing a coated metal object with varying coating thickness.

FIG. 6 is a perspective view, showing a stamp with concave spiral design.

FIG. 7 is a perspective view, showing a patterned surface with spiral design.

FIG. 8 is a perspective view, showing pattern-aided filiform entrapment.

FIG. 9 is a perspective view, showing a surface treated with spiral pattern design.

FIG. 10 is a perspective view, showing spiral patterns at various phases relative to each other.

FIG. 11 is a perspective view, showing a patterned surface with a diamond design.

FIG. 12 is a perspective view, showing a double spiral design.

FIG. 13 is a perspective view, showing an “s” spiral design.

### REFERENCE NUMERALS IN THE DRAWINGS

| | | | |
|---|---|---|---|
| 10 | metal | 12 | coating |
| 14 | coated metal object | 16 | rust filament |
| 18 | trough | 20 | peak |
| 22 | plateau | 24 | stamp |
| 26 | concave spiral | 28 | convex spiral |
| 30 | spiral pattern | 32 | entrapment region |
| 34 | convex diamond | 36 | diamond pattern |
| 38 | double spiral | 40 | “s” spiral |
| 42 | direction-controlling plateau | 44 | free end |
| 46 | entrapping end | 48 | loop |

### DETAILED DESCRIPTION OF THE INVENTION

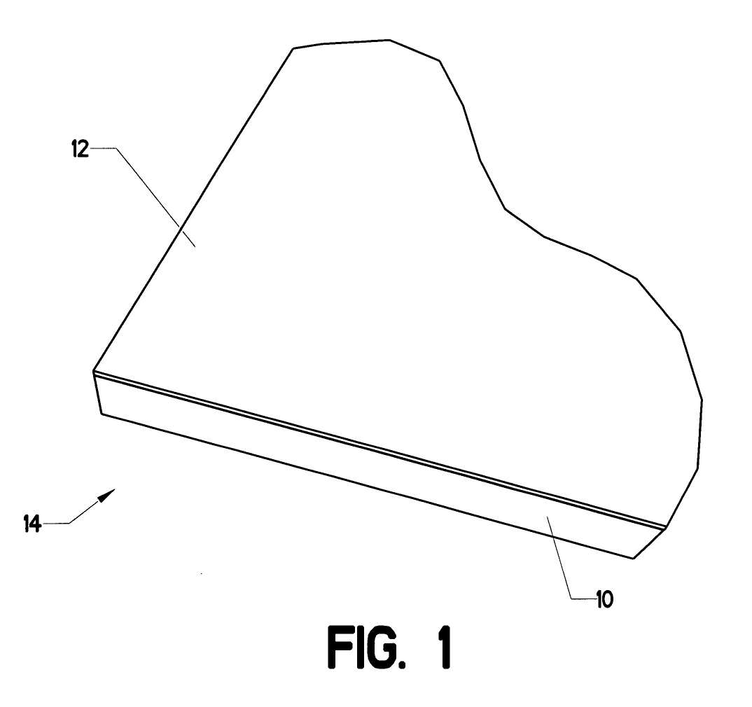

FIG. 1 shows a perspective view of a coated metal object, designated coated metal object 14. Coating 12 is deposited over metal 10. Metal 10 can be any metal such as iron and aluminum or any of their alloys, and coating 12 can be any type of coating applied to metal or metal alloys, including acrylic.

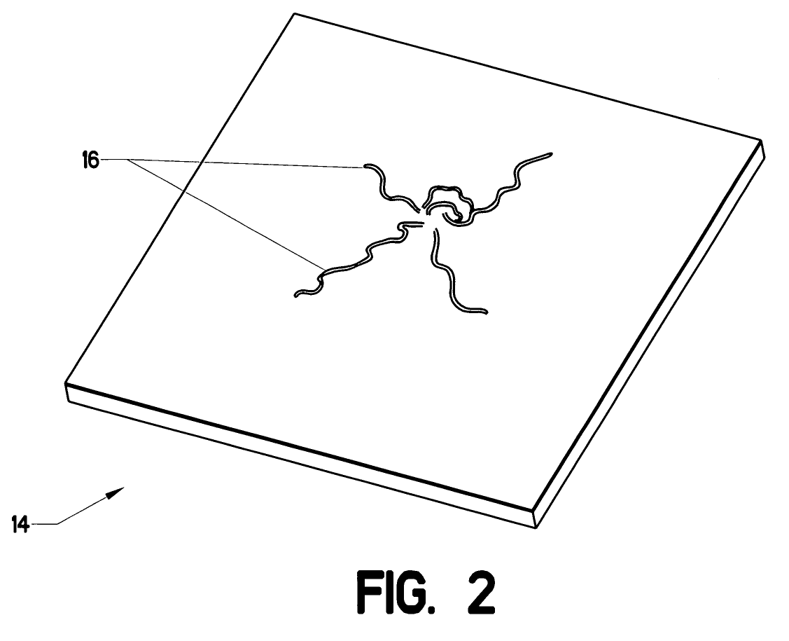

Coated metal objects are highly susceptible to underfilm corrosion. Underfilm corrosion begins when the metal substrate is exposed to moisture and oxygen. This can occur because of imperfections in the coating or because of the diffusion of oxygen and water through the coating. FIG. 2 illustrates typical filiform corrosion on a coated metal object. Rust filaments 16 follow paths that approximately radiate from a point of origin.

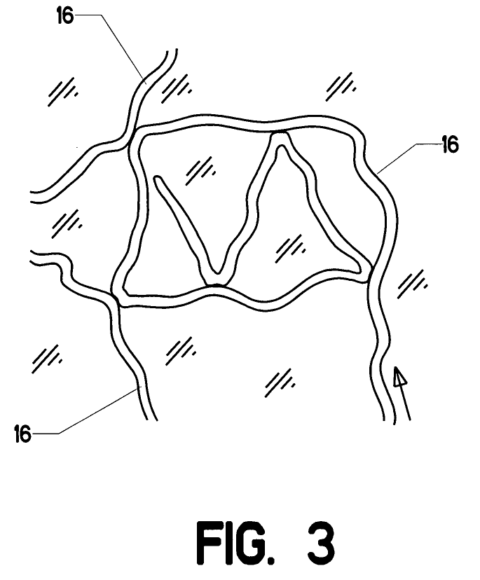

As filiforms grow or propagate, they occasionally have an opportunity to interact. Those skilled in the art know that an active filiform head will not cross an inactive tail of a rust filament. Instead filiform heads “reflect” from the tail and can become entrapped as the space available for the filiform to grow diminishes. FIG. 3 shows a detail view of the self-entrapment of rust filament 16. The arrow in FIG. 3 indicates the direction of propagation of filiform 16. As rust filament 16 propagates it reflects off both the tails of other filiform and its own tail. After several reflections, rust filament 16 creates an inactive perimeter which it cannot cross and its growth is thereby limited to the region within the inactive perimeter.

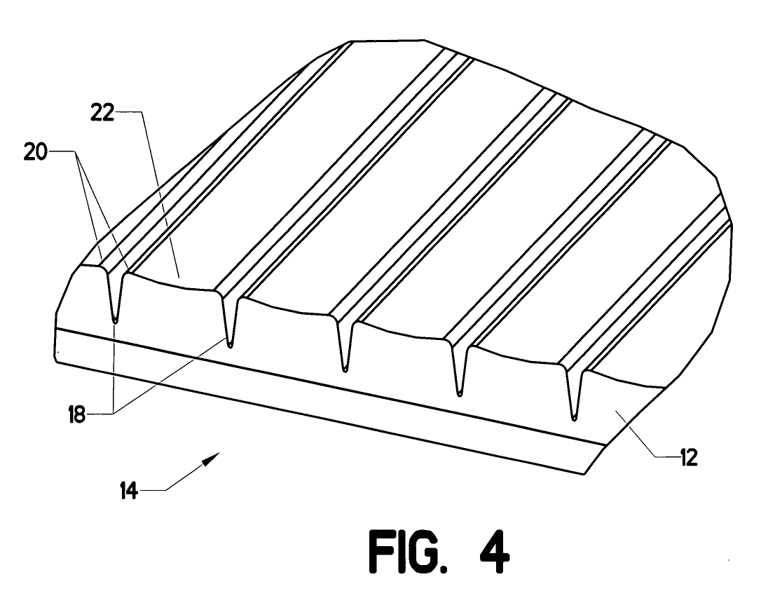

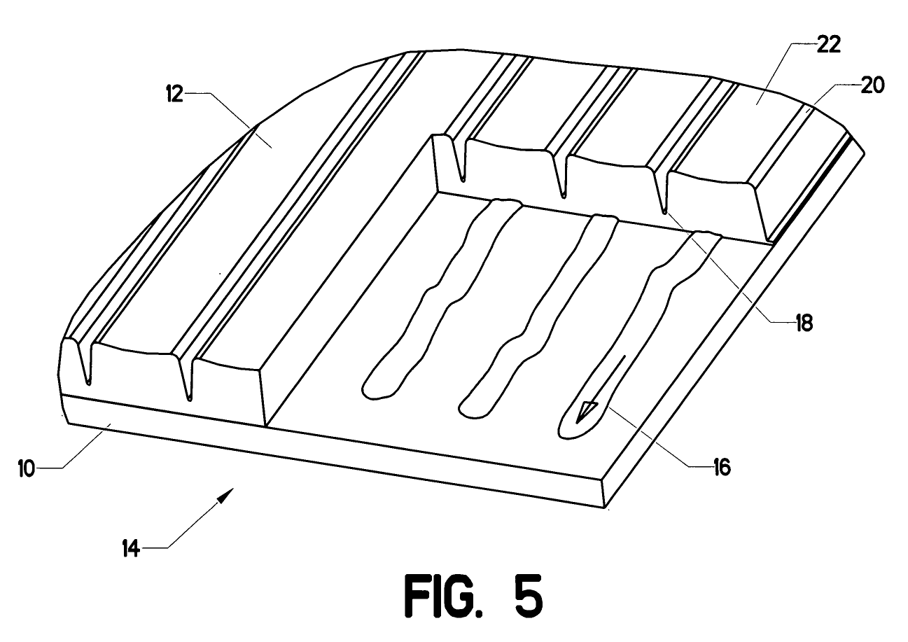

The general concept of this invention is to facilitate filiform self-entrapment by controlling the direction of filiform growth. It has been shown that filiform growth can be controlled by creating spatial variation of the coating thickness. FIG. 4 shows a coated metal object with varying coating thickness. Coating 12 is profiled in such a way to have a series of troughs 18, peaks 20, and plateaus 22. FIG. 5 shows a cut-away view of coated metal object 14 and illustrates how rust filaments 16 grow under plateaus 22. It is noted that rust filaments 16 tend to grow in a relatively straight path under plateaus 22 and do not cross trough 18 regions. Thus, the coating thickness controls the direction of filiform growth.

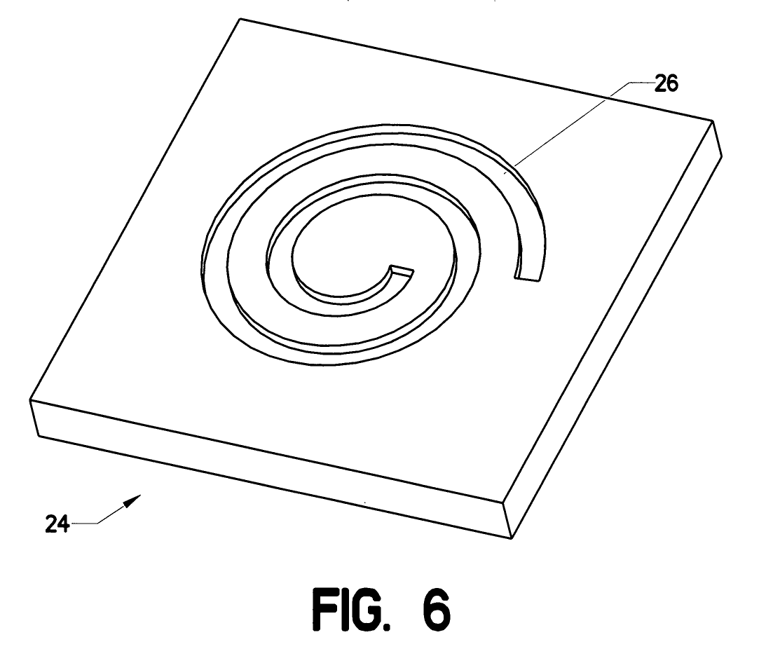

One way to create spatial variation of coating thickness involves the application of a micro-patterned polydimethylsiloxane (PDMS) stamp into a drying acrylic film. The PDMS stamps can be made by inexpensive soft-lithography, but other materials and techniques are applicable too. FIG. 6 shows a perspective view of stamp 24 impressed with the profile of concave spiral 26.

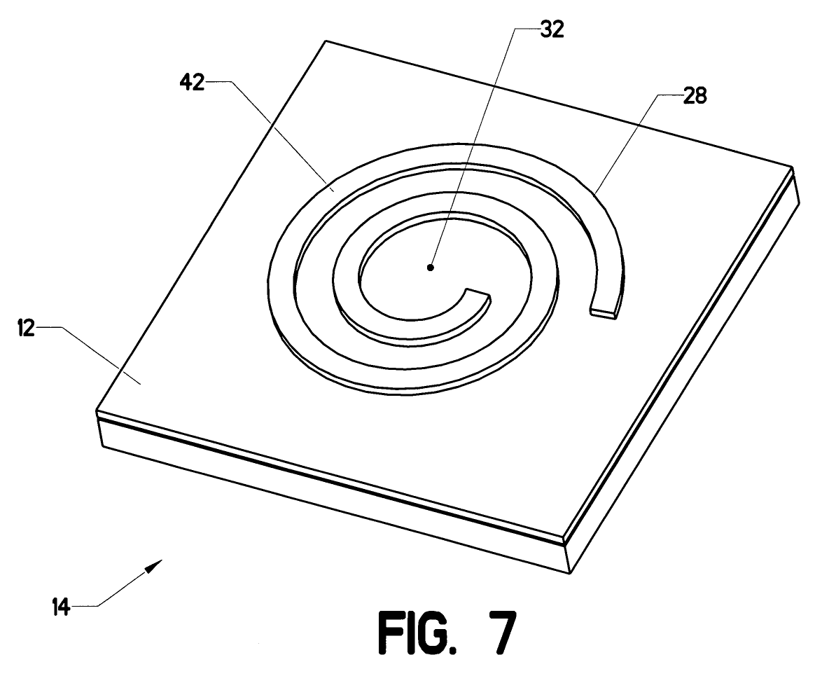

FIG. 7 shows a highly-magnified view of a patterned coating created by impressing stamp 24 of FIG. 6 onto a drying acrylic surface. Coating 12 is uniformly applied to the metal surface, and stamp 24 is pressed onto coating 12 while it is still wet. When the stamp is removed, convex spiral 28 is the resulting design on coating 12. The convex spiral creates direction-controlling plateau 42, which will control the propagation direction of any rust filiform that propagates into the spiral. This pattern remains on the coating after it dries. A rust filiform which intersects the spiral will tend to become entrapped within entrapment region 32.

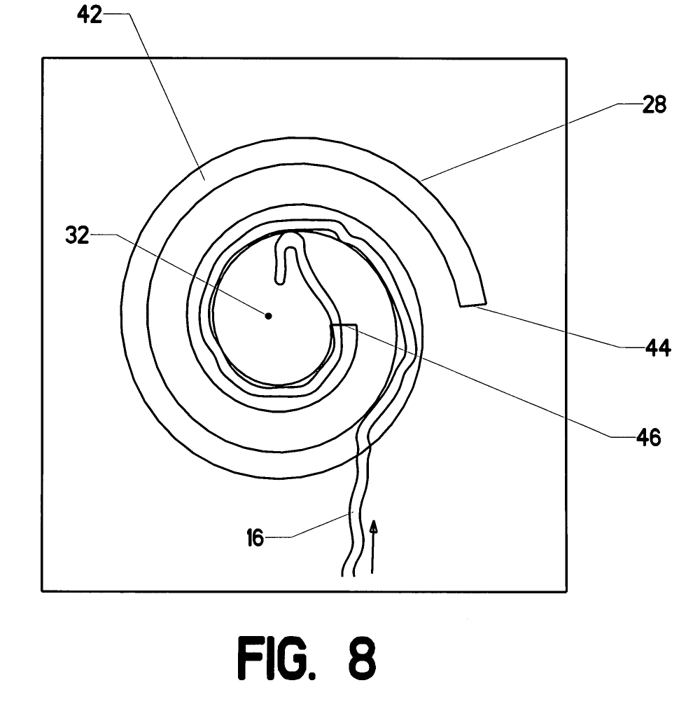

FIG. 8 illustrates how the pattern of the direction-controlling plateau entraps the filiform. Since rust filament 16 is only active at its head, it generally grows in one direction. When presented with the direction-controlling plateau, rust filament 16 follows the path much like a mole follows a tunnel (as demonstrated in FIG. 5, where rust filament 16 only grew under plateaus 22). When rust filament 16 reaches convex spiral 28 it follows the pattern into entrapment region 32. When the rust filament reaches this point, it has become entrapped and can no longer propagate. It will then reflect upon itself until further growth is impossible.

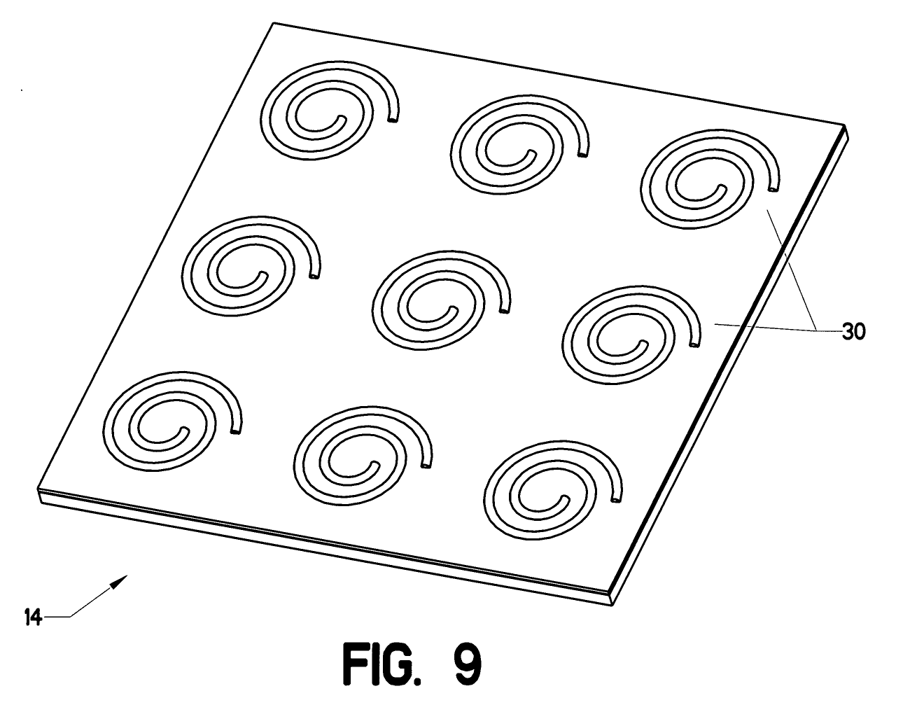

FIG. 9 shows how the entire surface of coated metal object 14 can be treated with spiral patterns 30. The application of spiral patterns 30 over the entire surface greatly limits the distance a filiform can grow before being entrapped.

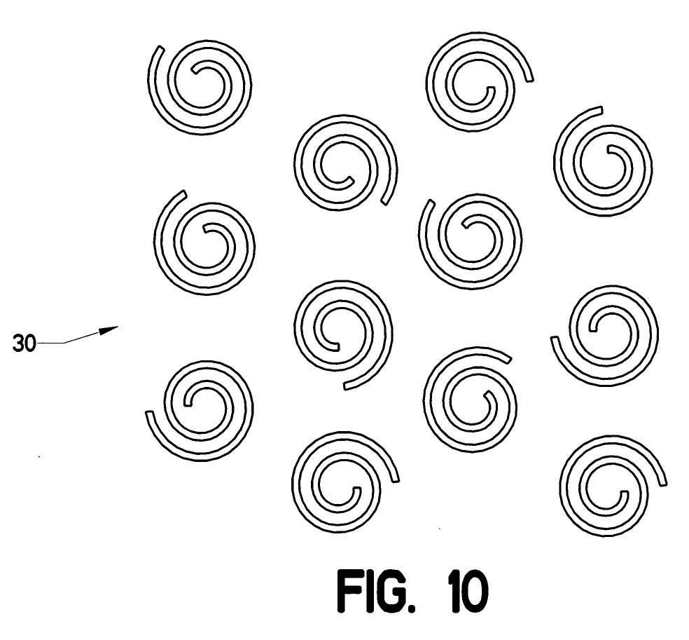

Since the precise origin of the filiforms and their bearings can seldom be anticipated various rotational offsets are used to “attract” filiforms into the patterns. FIG. 10 illustrates the rotational offset that can be used in spiral pattern 30. Each spiral is depicted at a phase angle that is relatively different than that of the adjacent spirals. The variation in phase angle or angular offset of the patterns increases the probability that a filiform will find a path to grow into entrapment region 32 regardless of which direction the filiform is growing.

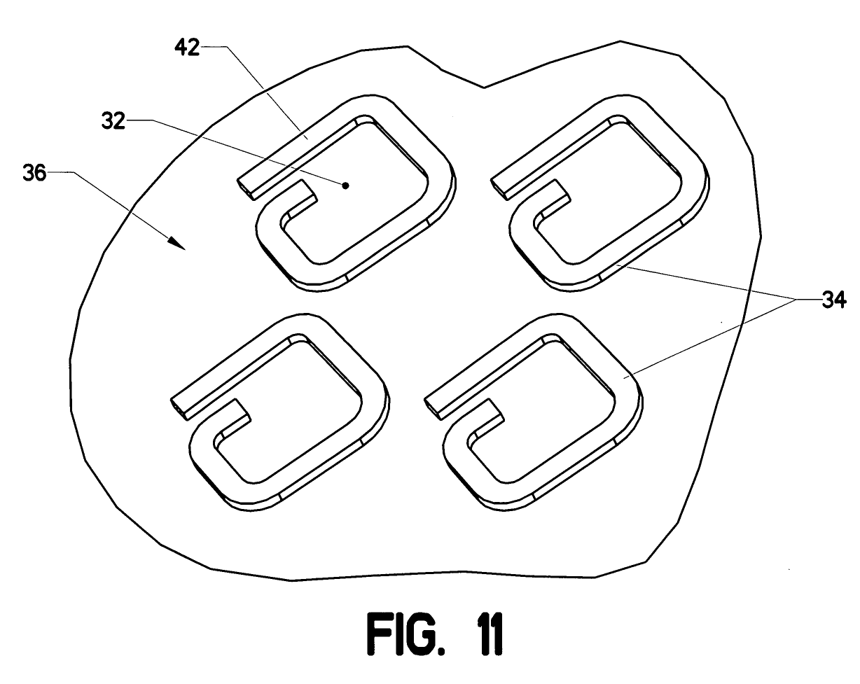

While FIG. 6, FIG. 7, FIG. 8, FIG. 9, and FIG. 10 illustrate an Archimedean-spiral design, it is contemplated that any type of relief that induces the self-trapping propagation of filiforms can be patterned on the coating. FIG. 11 shows a direction-controlling plateau 42 which assumes the shape of a convex diamond 34. A plurality of these are created in the coating to form create diamond pattern 36.

Of course, the patterns shown in FIGS. 7 through 11 are somewhat dependent upon the direction in which the filiform is travelling at the time it strikes the direction-controlling plateau. FIG. 8 serves to illustrate this phenomenon. In FIG. 8, rust filament 16 is travelling just east of north (assuming that the top part of the drawing view is “north”) when it first intersects direction-controlling plateau 42. It then travels along the spiral in an anticlockwise direction and becomes entrapped when it exits entrapping end 44 of the spiral. If, however, the rust filament had been travelling in a northwesterly direction, it would have still traveled along the spiral, but it would have done so in a clockwise direction. The filiform would then be likely to escape from free end 44 of the spiral.

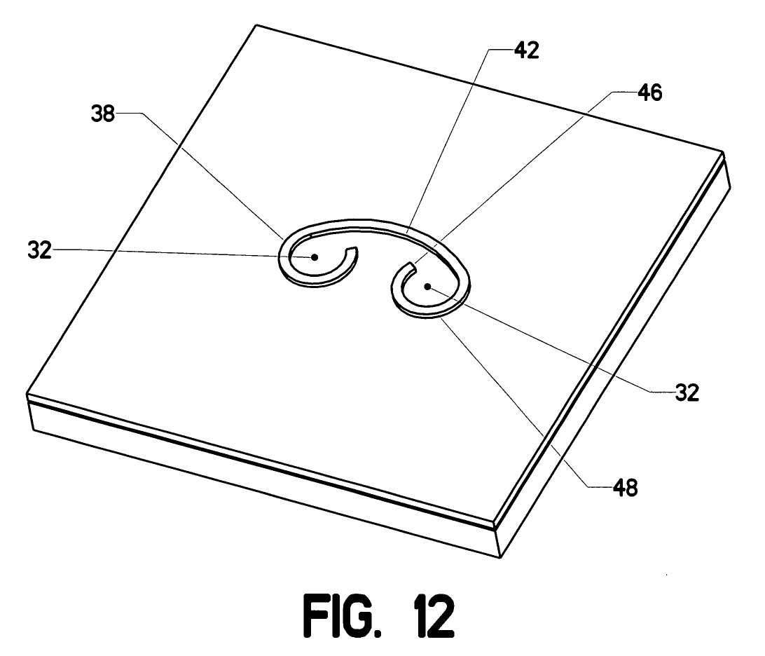

Of course, a pattern of spirals as shown in FIG. 9 ameliorates this problem since a filiform escaping from one spiral will likely be trapped by an adjacent spiral. However, it can be advantageous to provide a geometry for the direction-controlling plateaus which traps the rust filament no matter how the filament initially encounters the plateau. Such a geometry only includes entrapping ends. FIG. 12 shows double spiral 38. The reader will observe how the two entrapping ends 46 will likely direct an emerging rust filaform into one of the two entrapment regions 32. Thus, this type of geometry will tend to entrap a rust filament coming from any direction.

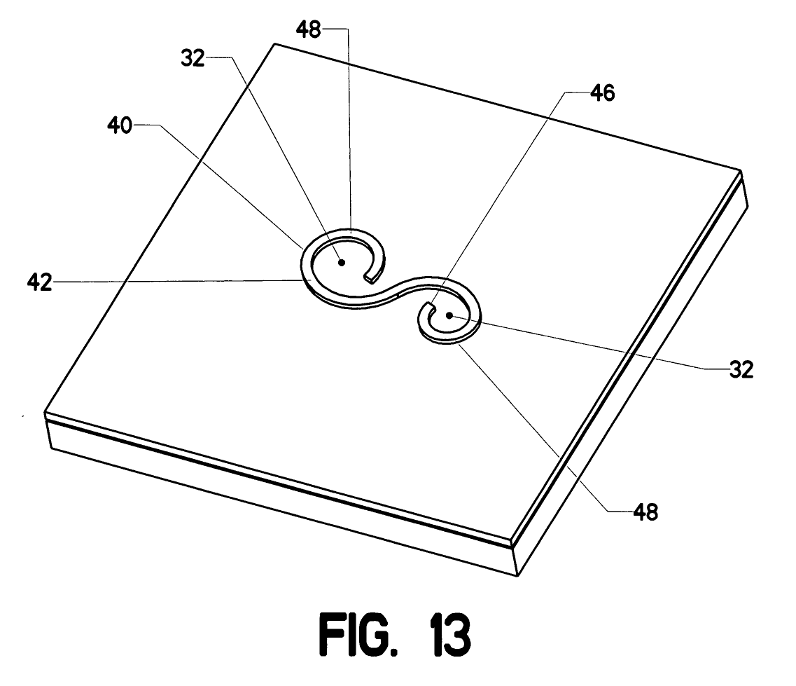

FIG. 13 shows “s” spiral 40. It too includes only entrapping ends 46. Each of these patterns operates to entrap the filiforms by directing the filiforms to grow in such a way that the filiform ultimately entraps itself. As illustrated in FIG. 8, filiforms will similarly follow the pattern of convex diamond 34, double spiral 38, and “s” spiral 40 as they grow and ultimately become entrapped in each of their respective entrapment regions.

As illustrated in the aforementioned examples, “paths” can be created in many different shapes to promote the self-entrapment of filiforms. Any path that directs the active head of the filiform to propagate in such a direction that the active head will become substantially surrounded by the inactive tail will work. Each of the aforementioned paths is configured to cause the filiform to propagate in such a direction that the inactive filiform tail creates an inactive perimeter around an entrapment region, where the active filiform head propagates angularly about the entrapment region. When the active filiform head is finally forced to enter the entrapment region, the filiform will become entrapped and will no longer propagate. FIGS. 12 and 13 illustrate the principles of creating effective geometry. Direction-controlling plateau 42 is preferably formed into one or more loops 48. Each loop features an entrapping end 46 which will tend to direct the active head of the filiform into the entrapment region 32 within each loop 48.

This description has specifically discussed the use of stamps to create the direction-controlling plateau pattern. Those skilled in the art will realize that many different techniques could be used to create the patterns. As a first example, a mask could be applied and the added thickness could be created by spraying on an additional layer of protective coating (with the additional layer forming the patterns such as shown at FIG. 10). Vapor deposition or electrostatic deposition could also be used.

In addition, the filament direction-controlling patterns can be created using techniques other than thickness variation. For example, light-controlled patterning can be used to vary the coating's chemical composition or porosity in order to control the direction of the filament propagation. Since corrosion occurs where moisture and oxygen diffuse through the coating and react with the metal substrate, the direction of filiform growth could also be controlled by spatial variation of coating porosity. Patterns of porosity variation can be used much like patterns of thickness variation to promote filiform entrapment as filiforms will follow paths of higher porosity.

Although the preceding description contains significant detail, it should not be construed as limiting the scope of the invention but rather as providing illustrations of the preferred embodiments of the invention. As an example, it is shown that embedding patterns on coated metal surfaces promotes the self-entrapment of filiform. Other methods for creating structural variations in surface thickness and composition can be used such as screen printing and surface etching.

Having herein described our invention, we claim:

1. A method of treating a coated surface in order to promote self-entrapment of a rust filaform, wherein said rust filaform has an active head and an inactive tail, comprising:
a. providing a piece of metal having an external surface;
b. providing a coating on said external surface;
c. varying the thickness of said coating in order to provide a thickened direction-controlling plateau, so that said active head of said rust filaform will propagate along said direction-controlling plateau when it intersects said direction-controlling plateau; and
d. shaping said direction-controlling plateau so that said active head of said rust filaform will propagate back into said inactive tail of said rust filaform, thereby entrapping said rust filaform and limiting further corrosion.

2. A method of treating a coated surface as recited in claim 1, wherein said step of shaping said direction-controlling plateau so that said active head of said rust filaform will propagate back into said inactive tail of said rust filaform, thereby entrapping said rust filaform and limiting further corrosion comprises:
a. forming said direction-controlling plateau as a long and narrow raised area; and
b. forming said long and narrow raised area into a loop, thereby creating an entrapment region within said loop.

3. A method of treating a coated surface as recited in claim 2, wherein said step of shaping said direction-controlling plateau so that said active head of said rust filaform will propagate back into said inactive tail of said rust filaform, thereby entrapping said rust filaform and limiting further corrosion further comprises providing said long and narrow raised area with an entrapping end positioned so that said active head will tend to leave said direction-controlling plateau at said entrapping end and enter said entrapment region.

4. A method of treating a coated surface as recited in claim 2, wherein said step of shaping said direction-controlling plateau so that said active head of said rust filaform will propagate back into said inactive tail of said rust filaform, thereby entrapping said rust filaform and limiting further corrosion comprises forming said direction-controlling plateau as a spiral.

5. A method of treating a coated surface as recited in claim 2, wherein said step of shaping said direction-controlling plateau so that said active head of said rust filaform will propagate back into said inactive tail of said rust filaform, thereby entrapping said rust filaform and limiting further corrosion comprises forming said direction-controlling plateau as a diamond.

6. A method of treating a coated surface as recited in claim 2, wherein said step of shaping said direction-controlling plateau so that said active head of said rust filaform will propagate back into said inactive tail of said rust filaform, thereby entrapping said rust filaform and limiting further corrosion comprises forming said direction-controlling plateau as a double spiral.

7. A method of treating a coated surface as recited in claim 2, wherein said step of shaping said direction-controlling plateau so that said active head of said rust filaform will propagate back into said inactive tail of said rust filaform, thereby entrapping said rust filaform and limiting further corrosion comprises forming said direction-controlling plateau as an “s” spiral.

8. A method of treating a coated surface as recited in claim 1, wherein said step of varying the thickness of said coating in order to provide a thickened direction-controlling plateau comprises stamping said coating with a stamp containing a concave cavity, with said concave cavity forming said thickened direction-controlling plateau.

9. A method of treating a coated surface as recited in claim 1, wherein said step of varying the thickness of said coating in order to provide a thickened direction-controlling plateau comprises adding an additional layer of said coating to form said thickened direction-controlling plateau.

10. A method of treating a coated surface as recited in claim 9, wherein said step of adding an additional layer of said coating to form said thickened direction-controlling plateau is carried out by applying a mask to said coating, with said mask containing a cutout in the form of said thickened direction-controlling plateau, and spraying additional coating material through said mask to form said thickened direction-controlling plateau

11. A method of treating a coated surface in order to promote self-entrapment of a rust filaform, wherein said rust filaform has an active head and an inactive tail, comprising:
a. providing a piece of metal having an external surface;
b. providing a coating on said external surface;
c. forming a long and narrow raised area in the form of a direction-controlling plateau, so that said active head of said rust filaform will propagate along said direction-controlling plateau when it intersects said direction-controlling plateau;
d. forming said direction-controlling plateau into a loop encircling an entrapment region; and
e. providing said loop with an entrapping end positioned so that said active head will tend to leave said direction-controlling plateau at said entrapping end and enter said entrapment region.

12. A method of treating a coated surface as recited in claim 11, wherein said step of shaping said direction-controlling plateau into a loop comprises forming said direction-controlling plateau as a spiral.

13. A method of treating a coated surface as recited in claim 11, wherein said step of shaping said direction-controlling plateau into a loop comprises forming said direction-controlling plateau as a diamond.

14. A method of treating a coated surface as recited in claim 11, wherein said step of shaping said direction-controlling plateau into a loop comprises forming said direction-controlling plateau as a double spiral.

15. A method of treating a coated surface as recited in claim 11, wherein said step of shaping said direction-controlling plateau into a loop comprises forming said direction-controlling plateau as an “s” spiral.

16. A method of treating a coated surface as recited in claim 11, wherein said step of forming a long and narrow raised area in the form of a direction-controlling plateau comprises stamping said coating with a stamp containing a concave cavity, with said concave cavity forming said thickened direction-controlling plateau.

17. A method of treating a coated surface as recited in claim 11, wherein said step of forming a long and narrow raised area in the form of a direction-controlling plateau comprises adding an additional layer of said coating to form said thickened direction-controlling plateau.

18. A method of treating a coated surface as recited in claim 11, wherein said step of forming a long and narrow raised area in the form of a direction-controlling plateau is carried out by applying a mask to said coating, with said mask containing a cutout in the form of said thickened direction-controlling plateau, and spraying additional coating material through said mask to form said thickened direction-controlling plateau.

19. A method of treating a coated surface as recited in claim 14, wherein said step of forming a long and narrow raised area in the form of a direction-controlling plateau comprises adding an additional layer of said coating to form said thickened direction-controlling plateau.

20. A method of treating a coated surface as recited in claim 15, wherein said step of forming a long and narrow raised area in the form of a direction-controlling plateau comprises adding an additional layer of said coating to form said thickened direction-controlling plateau.
